(19) United States
(12) Patent Application Publication
(10) Pub. No.: US 2021/0018908 A1
(43) Pub. Date: Jan. 21, 2021

(54) REMOTE DRIVING SYSTEM

(71) Applicant: TOYOTA JIDOSHA KABUSHIKI KAISHA, Toyota-shi (JP)

(72) Inventors: Yosuke TOKUDA, Toyota-shi (JP); Masahiro NISHIO, Toyota-shi (JP); Shuichiro TAKAHASHI, Toyota-shi (JP); Haruka YANO, Toyota-shi (JP); Taichi AMAKASU, Toyota-shi (JP)

(73) Assignee: TOYOTA JIDOSHA KABUSHIKI KAISHA, Toyota-shi (JP)

(21) Appl. No.: 16/885,521

(22) Filed: May 28, 2020

(30) Foreign Application Priority Data
Jul. 18, 2019 (JP) 2019-132966

(51) Int. Cl. G05D 1/00; B60W 60/00; B60W 50/14; B60W 40/08

(52) U.S. Cl. CPC G05D 1/0016; B60W 60/0025; B60W 2540/221; B60W 40/08; B60W 2040/0872; B60W 50/14

(57) ABSTRACT

A remote driving system has a manual operation section, an automatic operation section, an input section, and a remote driving terminal control section. The manual operation section is provided at a remote operation section that remotely drives a vehicle, and manual operation of the vehicle by a remote driver is carried out. The automatic operation section is provided at the remote operation section, and carries out automatic driving of the vehicle on the basis of information of a traveling state that is sensed by a vehicle sensing section. In a case in which the operator information is inputted to the input section, the remote driving terminal control section carries out control that switches driving operation of the vehicle from the manual operation section to the automatic operation section.

### CROSS-REFERENCE TO RELATED APPLICATION

This application is based on and claims priority under 35 USC 119 from Japanese Patent Application No. 2019-132966 filed on Jul. 18, 2019, the disclosure of which is incorporated by reference herein.

### BACKGROUND

### Technical Field

The present disclosure relates to a remote driving system.

### Related Art

Japanese Patent Application Laid-Open (JP-A) No. 2006-301723 (Patent Document 1) discloses a structure that, in a case in which it is judged that it is impossible for any of operators A through C to continue steering an automobile, switches to an operator other than the operators A through C.

### SUMMARY

The structure of Patent Document 1 is a system in which plural remote drivers exist. However, there are remote driving system in which a single remote driver drives a vehicle remotely.

In such a remote driving system, in a case in which manual operation by a remote driver becomes difficult due to the remote driver feeling poorly or the like, there is the possibility that the traveling state of the vehicle will fluctuate without the vehicle being remotely driven normally, and there is room for improvement.

In view of the above-described circumstances, an object of the present disclosure is to provide a remote driving system in which, in a situation in which a single remote driver is driving remotely, if a state arises in which manual operation by the remote driver is difficult, fluctuations in the traveling state of the vehicle can be suppressed.

A remote driving system of a first aspect includes: a manual operation section that is provided at a remote operation section that remotely drives a vehicle, and at which manual driving of the vehicle by a remote driver is carried out; an automatic operation section that is provided at the remote operation section, and that carries out automatic driving of the vehicle based on information of a traveling state that is sensed by a vehicle sensing section that senses the traveling state of the vehicle; an input section that is provided at the remote operation section, and to which operator information, which expresses that there is a state in which driving operation by the remote driver is difficult, is inputted; and a control section that, in a case in which the operator information is inputted to the input section, carries out control to switch driving operation of the vehicle from the manual operation section to the automatic operation section.

In the remote driving system of the first aspect, in a situation in which a single remote driver is driving remotely, if a state arises in which manual operation by the remote driver is difficult, operator information expressing that there is a state in which the driving operation by the remote driver is difficult is inputted to the input section. When operator information is inputted to the input section, the control section carries out control to switch the driving operation of the vehicle from the manual operation section to the automatic operation section. Then, on the basis of the information of the traveling state of the vehicle that is sensed by the vehicle sensing section, the automatic operation section carries out automatic driving of the vehicle. Due thereto, normal remote driving of the vehicle continues to be carried out. Therefore, the traveling state of the vehicle fluctuating can be suppressed in a case in which a state arises in which manual operation by the remote driver is difficult in a situation in which a single remote driver is driving remotely.

In a remote driving system of a second aspect, a notification section, which, in a case in which driving operation is switched from the manual operation section to the automatic operation section, notifies the remote driver that automatic driving of the vehicle is being carried out, is provided at the remote operation section.

In the remote driving system of the second aspect, in a case in which the driving operation is switched from the manual operation section to the automatic operation section, the notification section notifies the remote driver that automatic driving of the vehicle is being carried out. Due thereto, it is easy for the remote driver to recognize that the vehicle is in the automatic driving state, and needless operation of the remote driver can be reduced.

The notification section of a remote driving system of a third aspect is a load applying section that applies a load to driving operation at the manual operation section, in a case in which the driving operation is switched from the manual operation section to the automatic operation section.

In the remote driving system of the third aspect, in a case in which the driving operation is switched from the manual operation section to the automatic operation section, the load applying section applies load to the driving operation at the manual operation section. Due thereto, when the remote driver operates the manual operation section, the remote driver feels a load that is large as compared with the load at the time of the usual driving operation, and can recognize that the vehicle is not in the manual operation state. In this way, the remote driver can recognize that the vehicle is in the automatic driving state even if a visual or aural notification is not given. Therefore, the remote driver failing to see or failing to hear information relating to the operation state in a case in which visual or aural notification of automatic driving is given, can be suppressed.

A remote driving system of a fourth aspect further includes: a biometric information acquiring section that acquires biometric information of the remote driver; and a judging section that, based on biometric information acquired at the biometric information acquiring section, judges whether or not there is a state in which the driving operation by the remote driver is difficult, wherein the operator information is inputted to the input section in a case in which the judging section judges that there is a state in which the driving operation by the remote driver is difficult.

In the remote driving system of the fourth aspect, on the basis of the biometric information acquired by the biometric information acquiring section, the judging section judges whether or not there is a state in which driving operation by the remote driver is difficult. Then, if it is judged by the judging section that there is a state in which driving operation by the remote driver is difficult, the control section switches the driving operation of the vehicle from the manual operation section to the automatic operation section. In this way, in a case in which the remote driver feels unwell, the driving operation is automatically switched to the automatic operation section regardless of the intent of the remote driver. Therefore, the traveling state of the vehicle fluctuating can be suppressed as compared with a case in which a remote driver, who is having difficulty with operation, continues the driving operation.

As described above, in accordance with the present disclosure, there is the excellent effect that, in a situation in which a single remote driver is driving remotely, if a state arises in which manual operation by the remote driver is difficult, fluctuations in the traveling state of the vehicle can be suppressed.

### BRIEF DESCRIPTION OF THE DRAWINGS

Preferred embodiments will be described in detail based on the following figures, wherein:

FIG. 1 is a drawing showing an overview of a remote driving system relating to a first embodiment;

FIG. 2 is a block drawing showing hardware structures of a remote operation section relating to the first embodiment;

FIG. 3 is a block drawing showing functional structures of a vehicle and the remote operation section relating to the first embodiment;

FIG. 4 is a flowchart showing the flow of processings of switching between manual operation and automatic operation at the remote operation section relating to the first embodiment;

FIG. 5 is a block drawing showing functional structures of a remote driving system relating to a second embodiment;

FIG. 6 is a block drawing showing hardware structures of a remote operation section relating to the second embodiment; and

FIG. 7 is a flowchart showing the flow of processings of switching between manual operation and automatic operation at the remote operation section relating to the second embodiment.

### DETAILED DESCRIPTION

### First Embodiment

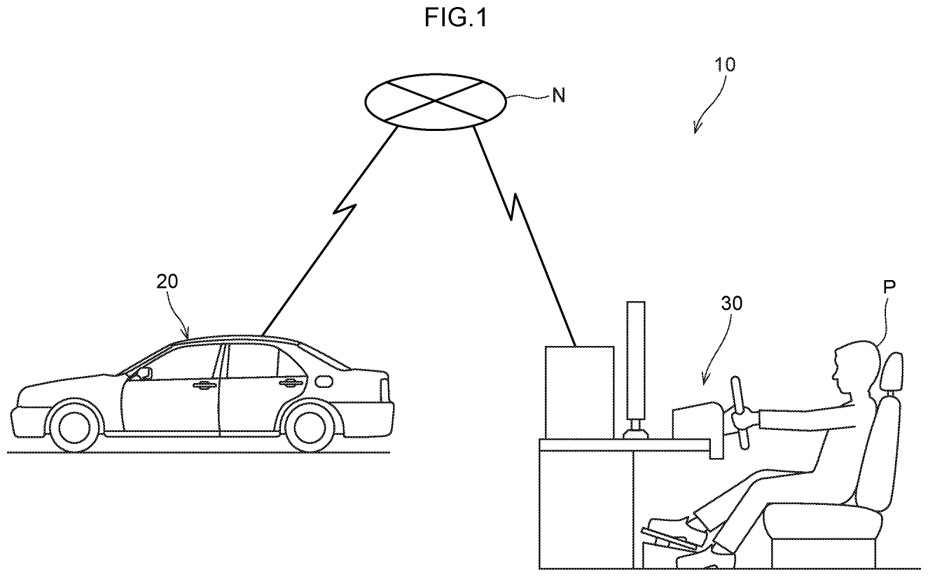

As shown in FIG. 1, a remote driving system 10 relating to a first embodiment has a vehicle 20 and a remote operation section 30. The vehicle 20 and the remote operation section 30 are connected by a predetermined network N (communication section) such that information can be can be transmitted in both directions. Note that, in the present embodiment, as an example, the vehicle 20 and the remote operation section 30 carry out the transmission of information without going through a server, but may carry out the transmission of information via an unillustrated server.

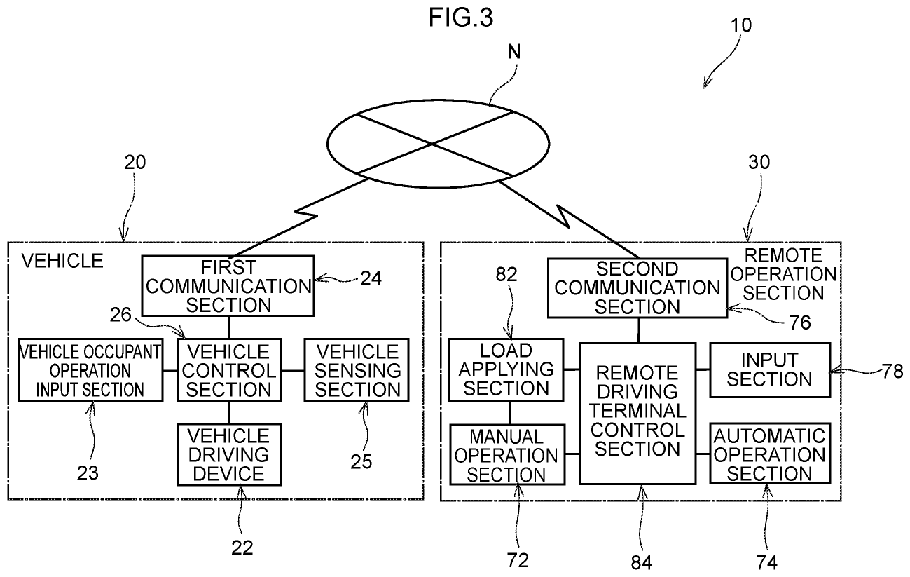

As shown in FIG. 3, the vehicle 20 is structured to include a vehicle driving device 22, a vehicle occupant operation input section 23, a first communication section 24, a vehicle sensing section 25 and a vehicle control section 26. The vehicle driving device 22 is structured to include an unillustrated engine, transmission and the like, and drives the vehicle 20 on the basis of operation by the vehicle occupant operation input section 23 or the remote operation section 30. The vehicle occupant operation input section 23 is structured to include an unillustrated steering wheel, acceleration pedal and brake pedal, and is operated by an unillustrated vehicle occupant (driver).

The first communication section 24 is connected to the network N. Transmission of information in both directions between the first communication section 24 and a second communication section 76 that is described later is possible. The vehicle sensing section 25 senses the traveling state of the vehicle 20 by sensing, for example, the steering angle, the velocity, the acceleration or the like of the vehicle 20. Further, the various types of information of the vehicle 20 that are sensed by the vehicle sensing section 25 are transmitted to the second communication section 76 (the remote operation section 30) via the first communication section 24 and the network N. The vehicle control section 26 is structured to include an unillustrated ECU (Electronic Control Unit), and carries out control of the respective sections of the vehicle 20. Note that the switching from the manual (driving) operation of the vehicle 20 by a vehicle occupant to the remote manual (driving) operation of the vehicle 20 by a remote driver P is carried out by, for example, the vehicle occupant pushing an unillustrated remote driving button.

The remote operation section 30 is described next.

(Hardware Structures)

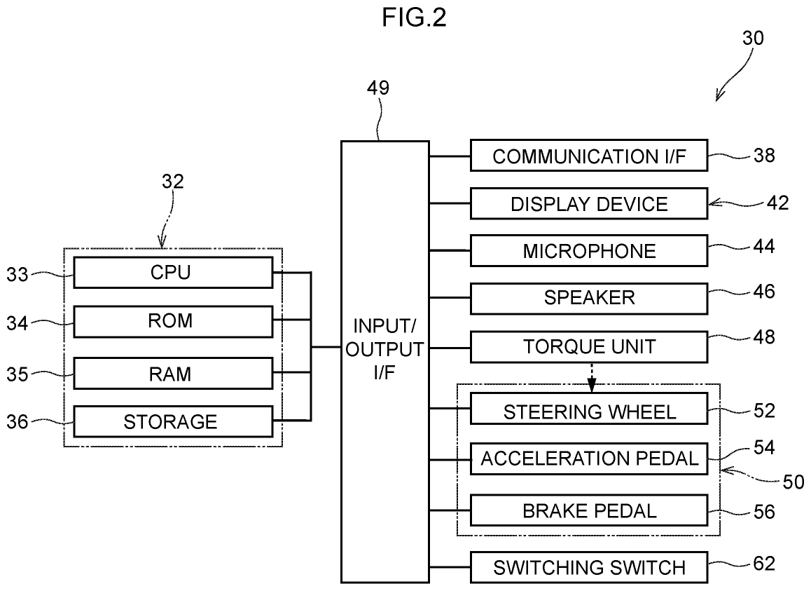

The remote operation section 30 shown in FIG. 2 has an ECU 32, a communication interface 38, a display device 42, a microphone 44, a speaker 46, a torque unit 48, an input/output interface 49, an operation unit 50, and a switching switch 62. In the following description, I/F is the abbreviation for interface. The ECU 32 and the above-described respective structures are connected so as to be able to communicate with one another via the input/output interface 49.

The ECU 32 has a CPU (Central Processing Unit) 33, a ROM (Read Only Memory) 34, a RAM (Random Access Memory) 35, and a storage 36.

The ROM 34 stores various types of programs and various types of data. The RAM 35, as a work area, temporarily stores programs or data. The storage 36 is structure by a flash ROM (Read Only Memory) as an example, and stores various types of programs, including the operating system, and various types of data. Due to the CPU 33 executing various types of programs such as a remote driving processing program and the like that are recorded in the ROM 34 or the storage 36, the CPU 33 carries out control of switching between manual operation by an unillustrated vehicle occupant of the vehicle 20 (see FIG. 1) and remote driving by a remote driver P (see FIG. 1).

The communication I/F 38 is connected to an unillustrated communication I/F of the vehicle 20 (see FIG. 1) via the network N (see FIG. 1). The display device 42 is structured by an unillustrated monitor and touch panel. The microphone 44 acquires the voice of the remote driver P. The voice information obtained by the microphone 44 is transmitted to the vehicle 20. The speaker 46 converts the voice information of the vehicle occupant transmitted from the vehicle 20 and other information into a voice, and outputs the voice. The torque unit 48 applies load (torque) to a steering wheel 52, which is described hereinafter, in accordance with an instruction from the ECU 32.

The operation unit 50 is structured to include the steering wheel 52, an acceleration pedal 54 and a brake pedal 56. The steering wheel 52 is structured so as to be able to change the steering angle of the vehicle 20 by being rotated around a shaft by the remote driver P. The acceleration pedal 54 is structured so as to be able to change the velocity and the acceleration of the vehicle 20 by being depressed by the remote driver P. The brake pedal 56 is structured so as to decelerate or stop the vehicle 20 by being depressed by the remote driver P.

The switching switch 62 is switched between on and off by the remote driver P. In the state in which the switching switch 62 is on, the vehicle 20 is driven remotely by manual operation of the remote driver P at the remote operation section 30. In the state in which the switching switch 62 is off, the vehicle 20 is driven remotely by automatic operation of the ECU 32 at the remote operation section 30.

[Functional Structures]

The remote operation section 30 remotely drives the vehicle 20 by realizing various types of functions by using the above-described hardware resources at the time of executing the remote driving program. The functional structures that the remote operation section 30 realizes are described hereinafter. Note that there are cases in which individual figure numbers are omitted in describing the structures shown in FIG. 1 and FIG. 2.

As shown in FIG. 3, the remote operation section 30 has, as the functional structures thereof, a manual operation section 72, an automatic operation section 74, the second communication section 76, an input section 78, a load applying section 82, and a remote driving terminal control section 84. These respective functional structures are realized due to the CPU 33 of the remote operation section 30 reading-out programs and information that are stored in the ROM 34 or the storage 36, and expanding and executing the programs in the RAM 35.

The manual operation section 72 is provided at the remote operation section 30. At the manual operation section 72, manual driving (manual operation) of the vehicle 20 by the remote driver P is carried out. Information, such as the amount of operation and the like at the manual operation section 72, are transmitted to the remote driving terminal control section 84.

The automatic operation section 74 is provided at the remote operation section 30. At the automatic operation section 74, automatic driving (automatic operation) of the vehicle 20 is carried out on the basis of information of the traveling state of the vehicle 20 that is sensed by the vehicle sensing section 25. Concretely, the automatic operation section 74 automatically carries out respective driving operations such as correcting the steering angle in accordance with the traveling path of the vehicle 20, and changing the velocity and the acceleration so as to maintain the inter-vehicle distances between the own vehicle and the vehicle in front and the vehicle behind, and stopping and starting back up in accordance with the color of a traffic signal, and the like.

The second communication section 76 is provided at the remote operation section 30. Further, the second communication section 76 is connected to the network N, and transmission of information in both directions between the second communication section 76 and the first communication section 24 is possible.

The input section 78 is provided at the remote operation section 30. At the input section 78, operator information, which expresses that there is a state in which driving operation by the remote driver P is difficult, is inputted. In the present embodiment, the on information and off information at the switching switch 62 are used as an example of the operator information that is inputted to the input section 78.

The on information at the switching switch 62 means information that is a request to switch the manual operation at the remote operation section 30 to automatic operation. The off information means information that is a request to switch the automatic operation at the remote operation section 30 to manual operation. Namely, a case in which on information is inputted to the input section 78 means that it is difficult for the remote driver P to carry out manual operation due to some reason (feeling poorly or the like), and automatic operation is requested. A case in which off information is inputted to the input section 78 means that the remote driver P wishes to return to manual operation.

The load applying section 82 is provided at the remote operation section 30. The load applying section 82 is an example of the notification section. In a case in which the operation section is switched from the manual operation section 72 to the automatic operation section 74, the load applying section 82 notifies the remote driver P (see FIG. 1) that automatic driving of the vehicle 20 is being carried out. Concretely, in a case in which the driving operation is switched from the manual operation section 72 to the automatic operation section 74, the load applying section 82 applies load to the driving operation at the manual operation section 72, and thereby notifies the remote driver P (causes the remote driver P to recognize) that there is a state of automatic driving.

The remote driving terminal control section 84 is an example of the control section, and is provided at the remote operation section 30. In a case in which operator information is inputted to the input section 78, the remote driving terminal control section 84 carries out control to switch the driving operation of the vehicle 20 from the manual operation section 72 to the automatic operation section 74.

[Operation and Effects]

Operation of the remote driving system 10 of the first embodiment is described next.

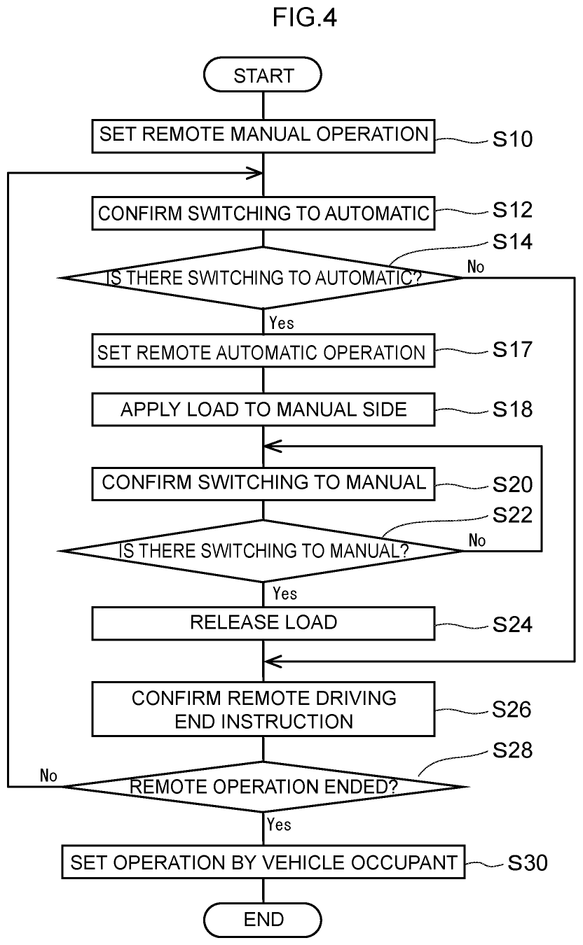

A flowchart showing the flow of the remote driving processing by the ECU 32 (see FIG. 2) is shown in FIG. 4. Note that, for the respective structures at the remote driving system 10 (the vehicle 20 and the remote operation section 30), reference is made to the respective drawings of FIG. 1 through FIG. 3, and the individual figure numbers are omitted.

At the ECU 32, the remote driving processing is carried out due to the CPU 33 reading-out the remote driving processing program from the ROM 34 or the storage 36, and expanding and executing the program in the RAM 35. Here, description is given of a case in which, due to the vehicle occupant pushing the remote driving button, the driving operation of the vehicle 20 changes over from manual operation by the vehicle occupant to manual driving by the remote driver P.

In step S10, the CPU 33 sets remote manual operation. Due thereto, at the remote operation section 30, remote driving of the vehicle 20 by the remote driver P becomes possible. Then, the program moves on to step S12.

In step S12, the CPU 33 confirms the absence/presence of information for switching from manual operation by the remote driver P at the remote operation section 30 to automatic operation. Concretely, the CPU 33 confirms the absence/presence of input of operator information at the input section 78. Then, the program moves on to step S14.

In step S14, the CPU 33 judges the absence/presence of switching to automatic operation. If it is judged that there is information for switching to automatic operation (S14: Yes), the program moves on to step S17. If it is judged that there is no information for switching to automatic operation (S14: No), the program moves on to step S26.

In step S17, the CPU 33 sets remote automatic operation. Due thereto, at the remote operation section 30, automatic operation of the vehicle 20 is started on the basis of the sensed information from the vehicle sensing section 25. Then, the program moves on to step S18.

In step S18, the CPU 33 applies load to the manual operation section 72 by operating the load applying section 82. Due thereto, when the remote driver P drives and operates the manual operation section 72, the remote driver P feels the load. Then, the program moves on to step S20.

In step S20, the CPU 33 confirms the absence/presence of information for switching from the automatic operation at the remote operation section 30 to manual operation by the remote driver P. Concretely, the CPU 33 confirms the absence/presence of input of operator information (a request) at the input section 78. Then, the program moves on to step S22.

In step S22, the CPU 33 judges the absence/presence of switching to manual operation. If it is judged that there is information for switching to manual operation (S22: Yes), the program moves on to step S24. If it is judged that there is no information for switching to manual operation (S22: No), the program moves on to step S20.

In step S24, the CPU 33 sets remote manual operation and operates the load applying section 82, and cancels the load that is applied to the manual operation section 72. Due thereto, when the remote driver P drives and operates the manual operation section 72, it is difficult for the remote driver P to feel the load (it is easy for the remote driver P to feel that manual operation is possible). Then, the program moves on to step S26.

In step S26, the CPU 33 confirms whether or not the remote driving button has been turned off by the vehicle occupant of the vehicle 20. Namely, the CPU 33 confirms an instruction to end remote driving. Then, the program moves on to step S28.

In step S28, the CPU 33 judges the absence/presence of ending of the remote driving. If it is judged that remote driving has ended (S28: Yes), the program moves on to step S30. If it is judged that the remote driving continues (S28: No), the program moves on to step S12.

In step S30, the CPU 33 sets manual operation by the vehicle occupant of the vehicle 20. Then, the program ends.

As described above, in the remote driving system 10, in a situation in which the single remote driver P is driving remotely, if a state arises in which manual operation by the remote driver P is difficult, operator information expressing that there is a state in which the driving operation by the remote driver P is difficult is inputted to the input section 78. When operator information is inputted to the input section 78, the remote driving terminal control section 84 carries out control to switch the driving operation of the vehicle 20 from the manual operation section 72 to the automatic operation section 74. Then, on the basis of information of the traveling state of the vehicle 20 that is sensed by the vehicle sensing section 25, the automatic operation section 74 carries out automatic driving of the vehicle 20. Due thereto, normal remote driving of the vehicle 20 continues to be carried out. Therefore, the traveling state of the vehicle 20 fluctuating can be suppressed in a case in which a state arises in which manual operation by the remote driver P is difficult in a situation in which the single remote driver P is driving remotely.

Further, in the remote driving system 10, in a case in which the driving operation is switched from the manual operation section 72 to the automatic operation section 74, the load applying section 82 that is an example of the notification section applies load to the driving operation at the manual operation section 72, and the remote driver P is thereby notified that automatic driving of the vehicle 20 is being carried out. Due thereto, it is easy for the remote driver P to recognize that the vehicle 20 is in the automatic driving state, and needless operation of the remote driver P can be reduced.

Moreover, at the remote driving system 10, in a case in which the driving operation is switched from the manual operation section 72 to the automatic operation section 74, the load applying section 82 applies load to the driving operation at the manual operation section 72. Due thereto, when the remote driver P operates the manual operation section 72, the remote driver P feels a load that is large as compared with the load at the time of the usual driving operation, and can recognize that the vehicle 20 is not in the manual operation state. In this way, the remote driver P can recognize that the vehicle 20 is in the automatic driving state even if a visual or aural notification is not given. Therefore, the remote driver P failing to see or failing to hear information relating to the operation state in a case in which visual or aural notification of automatic driving is given, can be suppressed.

### Second Embodiment

A remote driving system 90 relating to a second embodiment is described next.

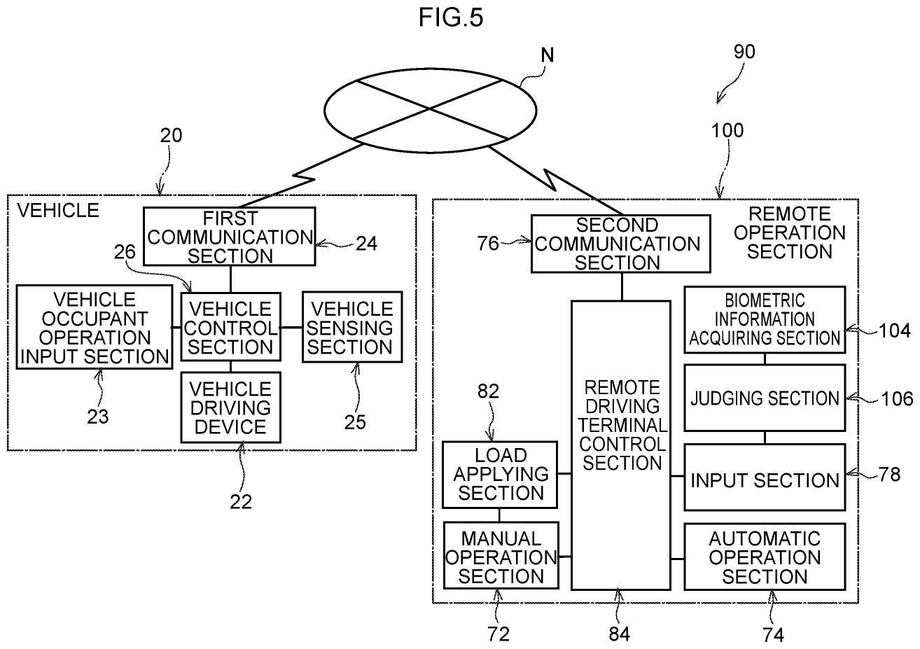

The remote driving system 90 shown in FIG. 5 has the vehicle 20 and a remote operation section 100. The vehicle 20 and the remote operation section 100 are connected by the predetermined network N (communication section) such that information can be can be transmitted in both directions. Note that, in the present embodiment, as an example, the vehicle 20 and the remote operation section 100 carry out the transmission of information without going through a server, but may carry out the transmission of information via an unillustrated server.

The remote operation section 100 differs from the first embodiment with regard to the point that a biometric information acquiring section 104 and a judging section 106 are added to the remote operation section 30 (see FIG. 3). Note that structures that are basically the same as those of the remote driving system 10 of the first embodiment (see FIG. 1) are denoted by the same reference numerals, and description thereof is omitted.

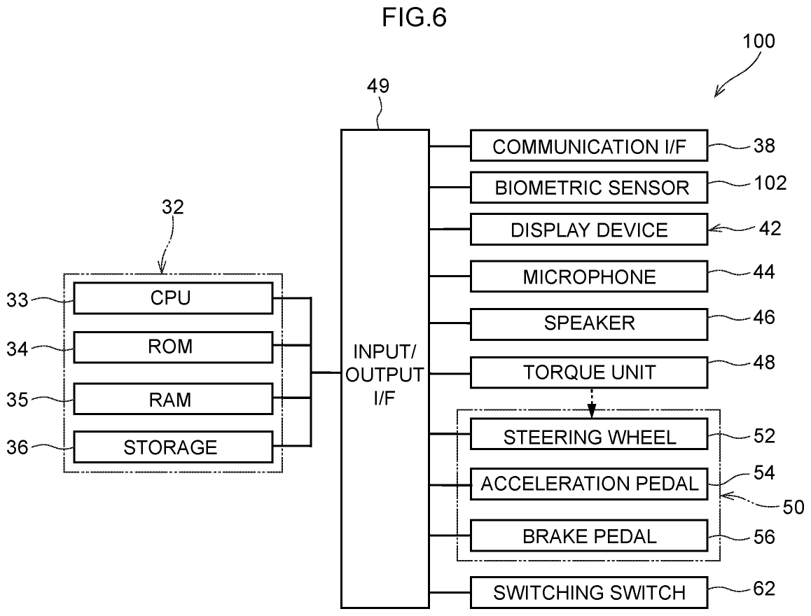

The remote operation section 100 shown in FIG. 6 differs from the first embodiment with respect to the point that a biometric sensor 102 is added to the remote operation section 30 (see FIG. 2).

In order to detect the physical condition of the remote driver P (see FIG. 1), the biometric sensor 102 detects biometric information such as, for example, the pulse, brain waves, blood pressure, heart rate, or the like. Further, the biometric sensor 102 transmits (outputs) the detected biometric information to the ECU 32.

The biometric information acquiring section 104 shown in FIG. 5 acquires the biometric information of the remote driver P by using the biometric sensor 102 (see FIG. 6). The biometric information of the remote driver P that is acquired by the biometric information acquiring section 104 is, as an example, transmitted to the judging section 106.

On the basis of the biometric information of the remote driver P that is acquired at the biometric information acquiring section 104, the judging section 106 judges whether or not there is a state in which the driving operation by the remote driver P is difficult. For example, numerical ranges of cases in which normal driving operation is possible are respectively set in advance for the pulse, brain waves, blood pressure, heart rate and the like. If the range of numerical values of even one of these is exceeded, it is judged that there is a state in which driving operation by the remote driver P is difficult.

If it is judged, at the judging section 106, that there is a state in which driving operation by the remote driver P is difficult, the previously-described operator information is inputted to the input section 78. Then, this operator information is transmitted to the remote driving terminal control section 84.

[Operation and Effects]

Operation of the remote driving system 90 of the second embodiment is described next.

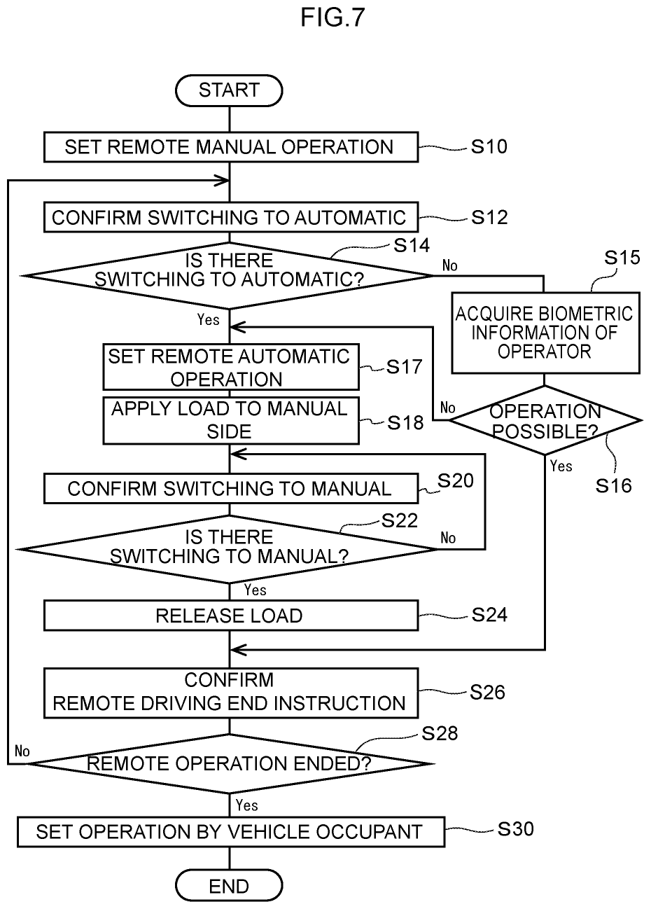

A flowchart showing the flow of the remote driving processing by the ECU 32 (see FIG. 6) is shown in FIG. 7. Note that, for the respective structures at the remote driving system 90, reference is made to FIG. 5 and FIG. 6, and the individual figure numbers are omitted. Further, steps that are basically the same as those of the first embodiment are denoted by the same step numbers, and description thereof is omitted.

The flowchart of the second embodiment differs from the flowchart of the first embodiment with respect to the point that step S15 and step S16 are added thereto.

In step S14, the CPU 33 judges the absence/presence of switching to automatic operation. If it is judged that there is information for switching to automatic operation (S14: Yes), the program moves on to step S17. If it is judged that there is no information for switching to automatic operation (S14: No), the program moves on to step S15.

In step S15, the CPU 33 acquires biometric information of the remote driver P by the biometric information acquiring section 104. Then, the program moves on to step S16.

In step S16, on the basis of the results of judging of the judging section 106, the CPU 33 judges whether or not there is a state in which driving operation by the remote driver P is difficult. If it is judged that driving operation by the remote driver P is possible (S16: Yes), the program moves on to step S26. If it is judged that driving operation by the remote driver P is difficult (S16: No), the program moves on to step S17.

As described above, in the remote driving system 90, on the basis of the biometric information acquired at the biometric information acquiring section 104, the judging section 106 judges whether or not there is a state in which driving operation by the remote driver P is difficult. Then, if it is judged by the judging section 106 that there is a state in which driving operation by the remote driver P is difficult, the remote driving terminal control section 84 switches the driving operation of the vehicle 20 from the manual operation section 72 to the automatic operation section 74. In this way, in a case in which the remote driver P feels unwell, the driving operation is automatically switched to the automatic operation section 74 regardless of the intent of the remote driver P. Therefore, the traveling state of the vehicle 20 fluctuating can be suppressed as compared with a case in which a remote driver, who is having difficulty with operation, continues the driving operation.

Note that the present disclosure is not limited to the above-described respective embodiments.

The notification section does not have to be provided in the remote driving systems 10, 90. Further, as another example of the notification section, notification may be given by display on the display device 42, without using the load applying section 82. Or, as another example of the notification section, notification may be given by a voice from the speaker 46.

In the remote driving system 90, it suffices for there to be at least one of the pulse, brain waves, blood pressure and heart rate as the biometric information. Further, as another example of the biometric information, body temperature information of the remote driver P may be used. Moreover, a posture sensing section that senses the seated posture of the remote driver P may be provided, and the biometric information may include information relating to the posture of the remote driver P.

Note that any of various types of processors other than the CPU 33 may execute the processings that the CPU 33 executes by reading out software (programs) in the above-described respective embodiments. Examples of processors in this case include PLDs (Programmable Logic Devices) whose circuit structure can be changed after production such as FPGAs (Field-Programmable Gate Arrays) and the like, or dedicated electrical circuits that are processors having circuit structures that are designed for the sole purpose of executing specific processings such as ASICs (Application Specific Integrated Circuits) and the like, or the like. Further, the above-described processings may be executed by one of these various types of processors, or may be executed by combining two or more of the same type or different types of processors (e.g., plurals FPGAs, or a combination of a CPU and an FPGA, or the like). Further, the hardware structures of these various types of processors are, more concretely, electrical circuits that combine circuit elements such as semiconductor elements and the like.

Further, the above-described embodiments describe aspects in which the remote driving processing program is stored in advance (installed) in the ROM 34 or the storage 36, but the present disclosure is not limited to this. The program may be provided in a form of being recorded on a recording medium such as a CD-ROM (Compact Disk Read Only Memory), a DVD-ROM (Digital Versatile Disk Read Only Memory), a USB (Universal Serial Bus) memory, or the like. Further, the remote driving processing program may be in a form of being downloaded from an external device via the network N.

What is claimed is:

1. A remote driving system comprising:
a manual operation section that is provided at a remote operation section that remotely drives a vehicle, and at which manual driving of the vehicle by a remote driver is carried out;
an automatic operation section that is provided at the remote operation section, and that carries out automatic driving of the vehicle based on information of a traveling state that is sensed by a vehicle sensing section that senses the traveling state of the vehicle;
an input section that is provided at the remote operation section, and to which operator information, which expresses that there is a state in which driving operation by the remote driver is difficult, is inputted; and
a control section that, in a case in which the operator information is inputted to the input section, carries out control to switch driving operation of the vehicle from the manual operation section to the automatic operation section.

2. The remote driving system of claim 1, wherein a notification section, which, in a case in which driving operation is switched from the manual operation section to the automatic operation section, notifies the remote driver that automatic driving of the vehicle is being carried out, is provided at the remote operation section.

3. The remote driving system of claim 2, wherein the notification section is a load applying section that applies a load to driving operation at the manual operation section, in a case in which the driving operation is switched from the manual operation section to the automatic operation section.

4. The remote driving system of claim 1, further comprising:
a biometric information acquiring section that acquires biometric information of the remote driver; and
a judging section that, based on biometric information acquired at the biometric information acquiring section, judges whether or not there is a state in which the driving operation by the remote driver is difficult,
wherein the operator information is inputted to the input section in a case in which the judging section judges that there is a state in which the driving operation by the remote driver is difficult.
